(19) United States
(12) Patent Application Publication
(10) Pub. No.: US 2008/0036416 A1
(43) Pub. Date: Feb. 14, 2008

(54) A Device and Method for Controlling the Motor of Treadmill

(76) Inventor: Chiu-Hsiang Lo, Taichung (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/459,886

(22) Filed: Jul. 25, 2006

(30) Foreign Application Priority Data
Apr. 14, 2006 (TW) 095113481

(51) Int. Cl. H02P 1/26

(52) U.S. Cl. 318/772

(57) ABSTRACT

This invention relates to a device and method for controlling the motor of treadmill, in which an operational frequency baseline value for the motor is pre-set in a frequency converter, according to the operational frequency of the motor being higher or lower than the pre-set baseline value, the six exiting coils of the motor would be controlled to be Y-wiring connected or Δ-wiring connected, there of the motor is in Y-wiring in low speed operation and is in Δ-wiring in high speed operation, with which high torque is maintained in whether the motor is running at high speed or low speed, and then speed stall is prevented to improve safety in use.

### FIELD OF THE INVENTION

This invention relates to a device and method for controlling the motor of treadmill, specifically the one to switch over automatically the motor of treadmill running in Y-wiring or Δ-wiring. When the motor is in Y-wiring in low speed operation or Δ-wiring in high speed operation, high torque is maintained, speed stall is prevented and safety in use is improved.

### BACKGROUND OF THE INVENTION

As per the generally recognized treadmill, for the purpose of assisting user, most of the treadmills are designed to have a mode of electrical operation, which are so-called electric treadmills. The basic structure of the generally recognized electric treadmill comprises a base frame, two rollers implemented on the base frame and a conveyer installed around the two rollers, a motor is implemented on the treadmill to drive one of the two rollers for running the conveyer. Since the motor used in the generally recognized electric treadmill is a 3 phase AC motor with specification of 200V/60 HZ, and the exiting coil is Δ-wiring connection (refer to FIG. 1), the torque output is fixed when the motor is running at whether low speed or high speed. When the motor is starting to run or running at medium and low speed, that is running in high current, which would cause the temperature of the motor rising and damaged. Further to modify a 220V/60 HZ Y-wiring motor into a Δ-wiring motor would be feasible, but the rating of the converter should be enlarged, and still, the modified motors being running in high current at starting, the problem of temperature, rising and damage remains.

### SUMMARY OF THE INVENTION

The main intention of this invention is to provide a method for the motor of treadmill to maintain high torque output at a certain range of running speed, with which the problem of speed stall caused by loading variation during the motor being running at high speed is resolved and the problem of temperature rising caused during the motor being running at low speed is improved. The procedure of controlling the motor in this invention is as following:

to pre-set an operational frequency baseline value for the motor; and
to control the six exiting coils of the motor being Y-wiring connected or Δ-wiring connected according to the operational frequency of the motor being higher or lower than the pre-set baseline value.

The second intention of this invention is to provide a control device for the motor of treadmill to maintain high torque output at a certain range of running speed, with which the problem of speed stall caused by loading variation during the motor being running at high speed is improved. The control device of this invention comprises:

a frequency converter connected with the motor, with which an operational frequency baseline value for the motor being pre-set;

a converter implemented in-between the motor and power supply, which including a transistor, a primary relay and a secondary relay, a switch being composed of the transistor and the primary relay.

When the running frequency of the motor exceed the baseline value pre-set in the frequency converter, the transistor energizes the primary relay making a circuitry on, and then the secondary relay is energized making another circuitry on.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a diagram showing the exiting coil of an ordinary motor in Y-wiring connection.

FIG. 2 is a diagram showing the exiting coil of an ordinary motor in Δ-wiring connection.

FIG. 3 is a control logic diagram of this invention.

FIG. 4 is a diagram showing the treadmill of this invention.

FIG. 5 is a diagram showing the frequency converter applied in this invention.

FIG. 5A is the circuit diagram showing connection of the primary relay and the secondary relay with the frequency converter of this invention.

FIG. 6 is the circuit diagram showing connection of the primary relay with the frequency converter of this invention.

FIG. 7 is the circuit diagram showing connection of the switch with the secondary relay of this invention.

FIG. 8 is a diagram showing the motor of this invention in Y-wiring connection.

FIG. 9 is a diagram showing the motor of this invention in Δ-wiring connection.

### DETAILED DESCRIPTION OF THE PREFERRED EMBODIMENT

### I. Technical Features of the Invention

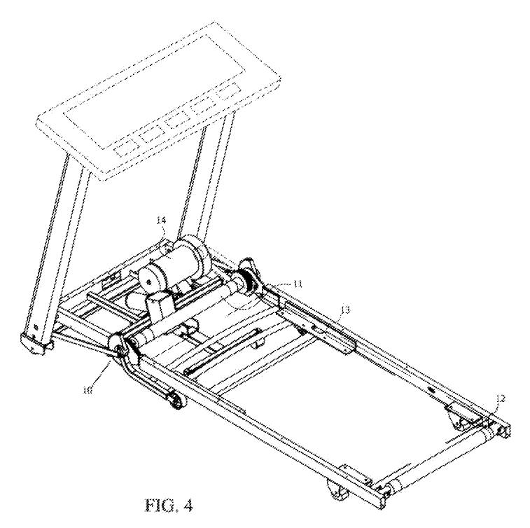

As shown on FIG. 4, the basic structure of the generally recognized electric treadmill comprises a base frame (10), two rollers (11)(12) implemented on the base frame and a conveyer (13) installed around the two rollers, a motor (14) is implemented on the treadmill to drive one of the two rollers. The motor employed in this invention comprises a frequency converter, a rotor, a stator and six exiting coils. The main intention of this invention is to control the torque output of the motor in the treadmill, with which the operational frequency of speed stall rises delaying the stall, high torque output being maintained even if the motor of the treadmill is running in a range of high speed, speed stall is prevented and safety in use is improved.

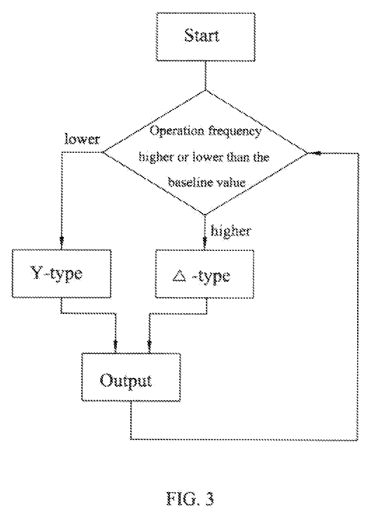

As shown on FIG. 3 and 4, to attain the object of what has been mentioned above, the main technical feature of this invention is a switching control on the wiring of the exiting coils for the motor of a treadmill, the motor employed in the embodiment comprises a frequency converter, a rotor, a stator and six exiting coils. The procedure of controlling the motor in this invention is as following:

to pre-set an operational frequency baseline value for the motor; and

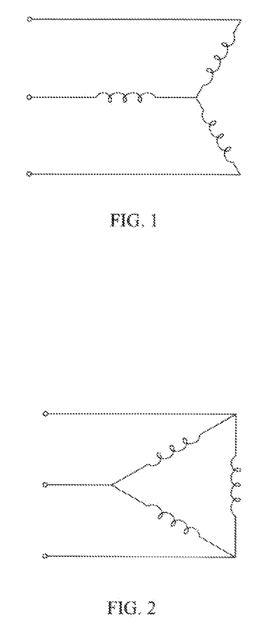

to control the six exiting coils of the motor being Y-wiring connected (Refer to FIG. 1) or Δ-wiring connected (Refer to FIG. 2) according to the operational frequency of the motor being higher or lower than the pre-set baseline value.

The motor employed in the embodiment is purchased directly from the market, the original specification is 220V/60 HZ and its exiting coils are Y-wiring connected, i.e. the motor would be- running on 220V/60 HZ when the motor is running with its operational frequency lower than the pre-set frequency baseline value and the three exiting coils W, U and V are Y-wiring connected.

In the embodiment of this invention, the supplier of the motor was asked to reserve the three exiting coils X, Y and Z, when the motor is running with its operational frequency lower than the pre-set frequency baseline value, it is running on 220V/60 HZ, the exiting coils X, Y and Z are not connected with the exiting coils W, U and V respectively but connected with each other and short-circuited, the motor is running with the three exiting coils W, U and V being Y-wiring connected. In the other case, when the motor is running with its operational frequency higher than the pre-set frequency baseline value, it is running on 127V/60 HZ; the exiting coils X, Y and Z are connected with the exiting coils W, U and V respectively to have the motor running in Δ-wiring connection.

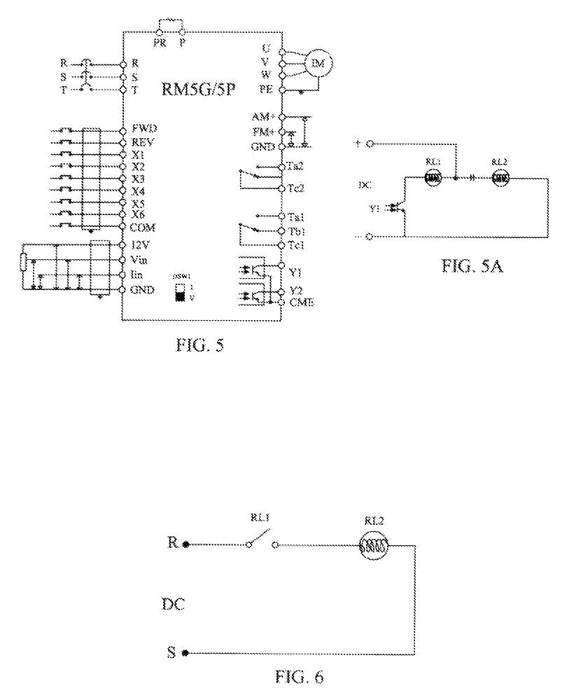

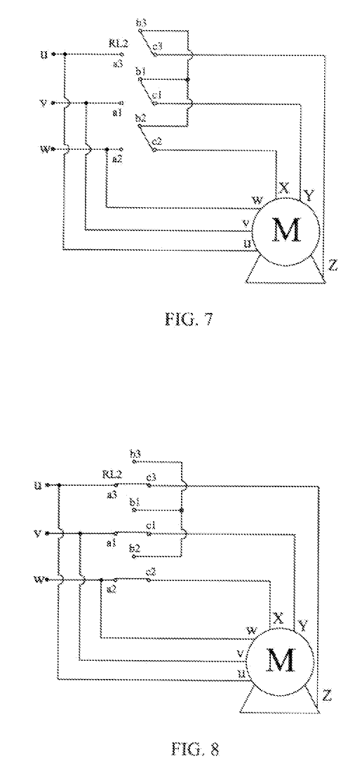

Referring to FIGS. 5, 5A, 6 and 7, in the embodiment of this invention, a converter is used to control the exiting coils being either Y-wiring connected or Δ-wiring connected, which comprises a transistor (Y1) implemented on the frequency converter (RM5G/5P) and a primary relay (RL1), and a secondary relay (RL2) implemented on the exiting coils; the transistor (Y1) and the primary relay (RL1) compose a switch (S1). A user or the designer set up parameters in advance on the frequency converter to pre-set the operational frequency baseline value for the motor.

As shown on FIGS. 5, 6, 7 and 8, when the motor is running with its operational frequency lower than the pre-set frequency baseline value, the secondary relay (RL2) is not activated, so that the terminal contact c2 of the exiting coil X being connected with the contact b2, the terminal contact c1 of the exiting coil Y being connected with the contact b1, the terminal contact c3 of the exiting coil Z being connected with the contact b3, the exiting coils X, Y and Z are not connected with the exiting coils W, U and V respectively, but said contacts b1, b2 and b3 are connected with each other making the exiting coils X, Y and Z connected and short-circuited, there of the motor is running with the three exiting coils W, U and V being Y-wiring connected.

As shown on FIGS. 5, 6, 7 and 9, when the motor is running with its operational frequency higher than the pre-set frequency baseline value, the transistor (Y1) would energize the primary relay (RL1) and activate the switch (S1) on, then energize the secondary relay (RL2) and activate the secondary relay (RL2), so that the terminal contact c2 of the exiting coil X being connected with the contact a2, the terminal contact c1 of the exiting coil Y being connected with the contact a1, the terminal contact c3 of the exiting coil Z being connected with the contact a3, the exiting coils X, Y and Z are connected with the exiting coils W, U and V respectively, there of the motor would be running with the exiting coils X, Y and Z connected in Δ-wiring with the three exiting coils W, U and V.

In the embodiment of this invention, the operational frequency baseline value has been pre-set as 90 HZ, yet to be adjusted depending on conditions of the treadmill itself to be applied, the inventor found the adoptable operational frequency baseline value would be pre-set as between 80 HZ and 120 HZ.

### II. Theoretical Basis of the Invention

There are two kinds of wiring connections for the stator of an induction motor, which are Y-wiring connection and Δ-wiring connection. In the circumstances of constant voltage of power supply, if Δ-wiring connection would have been used in high speed running and Y-wiring connection been used in low or medium speed, the line voltage of the motor in Y-wiring connection will be √3 times than that of the motor in Δ-wiring connection, therefore the current in high speed running will be increased √3 times than the current in high speed running in original Y-wiring connection. Since the motor used in this invention is made based on a 220V/60 HZ wiring connection, the rotational torque remains its features when the motor is running in low speed or medium speed.

The operational frequency baseline value of the motor employed in this invention was pre-set as 90 HZ, the motor would he running on 220V/60 HZ in Y-wiring connection when the motor is running below 90 HZ of operational frequency. The operational torque output of the motor would be the same as what is in the specification, so would be the consumed current. When the motor is running over 90 HZ of the pre-set operational frequency baseline value, the motor would be switched automatically to being running on 127V/60 HZ in Δ-wiring connection. Since the power supply to the motor remains 220V, the current would be increased √3 times, therefore the operation frequency of speed stall of a motor running in high speed would be raised and the speed would be delayed, high operational torque output would be maintained for the high-speed-running motor and the speed stall which might happen during on-loading would he avoided.

While we have shown and described in accordance with the present invention, it should be clear to those skilled in the art that further embodiments may be made without departing from the scope of the present invention.

What is claimed is:

1. A method for controlling the motor of treadmill, a motor is installed on a treadmill that comprises a frequency converter, a rotor, a stator and six exiting coils, and the procedures of the method for controlling the motor comprise:
to pre-set an operational frequency baseline value for the motor; and
to control the six exiting coils of the motor being Y-wiring connected or Δ-wiring connected according to the operational frequency of the motor being higher or lower than the pre-set baseline value.

2. The method for controlling the motor of treadmill as claimed in claim 1, wherein a converter is used to control the exiting coils being either Y-wiring connected or Δ-wiring connected, which comprises a transistor implemented on the frequency converter, a primary relay and a secondary relay implemented on the exiting coils, and when the motor is running with its operational frequency higher than the pre-set frequency baseline value, the transistor would energize the primary relay and the secondary relay will be activated.

3. The method for controlling the motor of treadmill as claimed in claim 1, wherein the operational frequency baseline value for the motor is pre-set by setting up a parameter on the frequency converter.

4. The method for controlling the motor of treadmill as claimed in claim 1, wherein the six exiting coils W, U, V, and X, Y, Z of the motor are connected in Y-wiring or Δ-wiring as following manners:
when the exiting coils are in Y-wiring connection, the exiting coils X, Y and Z are not connected with the exiting coils W, U and V respectively but connected with each other to he short-circuited: and
when the exiting coils are in Δ-wiring connection, the exiting cods X, Y and Z are connected with the exiting coils W, U and V respectively.

5. The method for controlling the motor of treadmill as claimed in claim 1, wherein the pre-set operational frequency baseline value for the motor is between 80 HZ and 120 HZ.

6. The method for controlling the motor of treadmill as claimed in claim 1, wherein the motor is running on 220V/60 HZ when its operational frequency is lower than the pre-set frequency baseline value, and the exiting coils of the motor are in Y-wiring connection.

7. The method for controlling the motor of treadmill as claimed in claim 1, wherein the motor is running on 127V/60 HZ when its operational frequency is higher than the pre-set frequency baseline value, and the exiting coils of the motor are in Δ-wiring connection.

8. A method for controlling the motor of treadmill, the structure of the treadmill comprises a base frame, two rollers implemented on the base frame and a conveyer installed around the two rollers, a motor implemented on the treadmill for driving one of said two rollers, wherein the motor comprises a frequency converter, a rotor, a stator and six exiting coils, and the procedures of the method for controlling the motor comprise:
to pre-set an operational frequency baseline value for the motor; and
to control the six exiting coils of the motor being Y-wiring connected or Δ-wiring connected according to the operational frequency of the motor being higher or lower than the pre-set baseline value.

9. The method for controlling the motor of treadmill as claimed in claim 8, wherein a converter is used to control the exiting coils being either Y-wiring connected or Δ-wiring connected, the converter comprises a transistor implemented on the frequency converter, a primary relay and a secondary relay implemented on the exiting coils, the transistor energizes the primary relay making a circuitry on, and then the secondary relay is energized making another circuitry on.

10. The method for controlling the motor of treadmill as claimed in claim 8, wherein the operational frequency baseline value for the motor is pre-set by setting up a parameter on the frequency converter.

11. The method for controlling the motor of treadmill as claimed in claim 8, wherein the six exiting coils W, U, V, and X, Y, Z of the motor are connected in Y-wiring or Δ-wiring as following:
when the exiting coils are in Y-wiring connection, the exiting coils X, Y and Z are not connected with the exiting coils W, U and V respectively but connected with each other to he short-circuited; and
when the exiting coils are in Δ-wiring connection, the exiting coils X, Y and Z are connected with the exiting coils W, U and V respectively.

12. The method for controlling the motor of treadmill as claimed in claim 8, wherein the pre-set operational frequency baseline value for the motor is between 80 HZ and 120 HZ.

13. The method for controlling the motor of treadmill as claimed in claim 8, wherein the motor is running on 220V/60 HZ when its operational frequency is lower than the pre-set frequency baseline value, the exiting cods of the motor are in Y-wiring connection.

14. The method for controlling the motor of treadmill as claimed in claim 8, wherein the motor is running on 127V/60 HZ when its operational frequency is higher than the pre-set frequency baseline value, the exiting coils of the motor are in Δ-wiring connection,

15. An electrical treadmill that comprises:
a treadmill;
a motor implemented on the treadmill with six exiting coils on the motor; and
a control device controlling the six exiting coils of the motor being Y-wiring connected or Δ-wiring connected, and the control device comprising:
a frequency converter connected with the motor, with which an operational frequency baseline value for the motor being pre-set, and
a converter implemented between the motor and power source;
wherein the original wiring of the motor being in Y-wiring connection; when the operational frequency of the motor being higher than the frequency baseline value pre-set in the frequency converter, the converter would switch over wiring connection on the exiting coils from Y-wiring to Δ-wiring.

16. The treadmill as claimed in claim 15, wherein the converter comprises a transistor implemented on the frequency converter, a primary relay and a secondary relay, a switch is composed of the transistor and the primary relay; when the running frequency of the motor exceed the baseline value pre-set in the frequency converter; the transistor energizes the primary relay making a circuitry on, and then the secondary relay is energized making another circuitry on.

17. The treadmill as claimed in claim 15, wherein the treadmill further comprises:
a base frame;
two rollers implemented on the base frame; and
a conveyer installed around the two rollers:
a motor implemented on the treadmill to drive one of the two rollers.
